(19) United States
(12) Patent Application Publication
(10) Pub. No.: US 2021/0300264 A1
(43) Pub. Date: Sep. 30, 2021

(54) PICKUP TRUCK STORAGE CURTAIN

(71) Applicant: Nicholas L. Kowalski, Traverse City, MI (US)

(72) Inventor: Nicholas L. Kowalski, Traverse City, MI (US)

(21) Appl. No.: 17/213,722

(22) Filed: Mar. 26, 2021

Related U.S. Application Data
(60) Provisional application No. 63/002,683, filed on Mar. 31, 2020.

(51) Int. Cl. B60R 11/06

(52) U.S. Cl. CPC B60R 11/06; B60R 2011/004

(57) ABSTRACT

A storage curtain device for hanging from the front wall of a pickup truck bed, provided with storage features for stowing small tools, equipment, and cargo. The storage curtain device comprises a curtain body portion secured to a cap, the cap designed to fit over the upper edge of the front wall of the pickup truck bed.

### RELATED APPLICATIONS/PRIORITY BENEFIT CLAIM

This application claims the benefit of U.S. Provisional Application No. 63/002,683, filed Mar. 31, 2020 by the same inventor (Kowalski), the entirety of which provisional application is hereby incorporated by reference.

### FIELD

The subject matter of the present application is in the field of devices for storing tools and equipment in the bed of a pickup truck.

### BACKGROUND

Devices adapted for installation across the width of truck cargo beds to secure, partition, or store cargo and tools are known.

U.S. Pat. No. 4,168,667 to Loomis shows a load-restraining device for a truck trailer. The device includes a curtain adjustably suspended from an overhead support extending laterally across the top of the trailer, and mounted for longitudinal movement therein. The curtain includes laterally-extending pockets, each of which carries a load-restraining belt. Belt hooks on ends of the belts cooperate with rails in the sidewalls of the trailer, with a belt tensioner or buckle at the center of each belt.

U.S. Pat. No. 5,201,561 to Brown shows a storage box for use on pickup trucks having a lid and flap which are hinged and secured to the truck bed.

U.S. Pat. No. 5,340,183 to Horian shows a partition for a vehicle having a front panel, side panels and attachments hinged together for deployment from a stowed position against the wall of a vehicle cargo area to a stand-alone extension forming smaller cargo compartments.

U.S. Pat. No. 5,628,442 to Wayne shows a package-retaining accessory including a closure attachable to a wall or a divider of the cargo area. The accessory is comprised of a collapsible fabric material or a rigid material. The top portion in the fabric embodiment is supported in an upright position by extension lines or brackets attached to the sides of the cargo area.

U.S. Pat. No. 5,927,783 to Baka shows a modular universal shelf for an open load bed of a pickup truck.

U.S. Pat. No. 8,192,118 to Zahorec et al shows a stowable storage net for a pickup truck storage area, attached with loops to hooks attached to surfaces in the storage area.

U.S. Pat. No. 8,281,967 to Evans shows a storage unit anchored in a truck bed with side modules forming a track that provides both easy pull-out and security in a storage position within the truck bed.

U.S. Published Patent Application No. US 2002/0053582 A1 to Eipper shows a container that can be locked and fastened to a vehicle with lockable fastening devices, the container being made of collapsible, impenetrable material and capable of being carried as a bag when detached.

U.S. Published Patent Application No. US 2011/0121045 A1 to Agerton shows a tool organizer comprising a rectangular plate with a rectangular pad having spaced apart matching tool cutouts therein.

The commercially available Hitchmate™ truck bed net cargo carrying bag organizer and tailgate accessory appears to comprise a soft bag hanging by straps or loops from a bar extending and possibly tensioned between the sidewalls of a pickup truck bed.

### BRIEF SUMMARY

The present invention is a generally flat, panel-like storage curtain detachably mounted to hang cross-wise in a pickup truck bed. The storage curtain comprises a plurality of compartments, pouches, or other “holding” features for storing and/or securing small-to-medium cargo such as (but not limited to) tools and equipment. The storage curtain may be made from various rigid or flexible materials, including metal and fabric, provided it hangs freely in a generally vertical plane across the pickup truck bed.

The upper side of the storage curtain further comprises a rigid elongated hook-like “cap” extending thereacross, configured to hook directly onto the upper edge of the front wall of the pickup truck bed, adjacent the cab, in non-marring fashion. The cap in one form has an inverted hook shape, in a preferred form a with a generally J-shaped configuration opening forwardly and downwardly, and may comprise a single continuous elongated hook-like cap portion or an array of spaced hook-like cap portions extending across the upper side of the curtain. The inverted hook shape may be squared or rounded or have other cross-sectional variations to better fit the upper edge of the front wall of the pickup truck bed, as needed.

The storage curtain hangs in generally parallel fashion downwardly from a rear wall (or spaced rear wall portions) of the cap, the height of the curtain being less than the height of the front wall of the pickup truck bed so that the lower side of the curtain is spaced above the floor of the pickup truck bed when mounted.

In a further form, the storage curtain is detachably connected to the rear wall (or spaced rear wall portions) of the cap. The cap may accordingly be left in place on, or even permanently attached to, the upper edge of the front wall of the pickup truck bed.

The upper side of the cap is preferably sufficiently thin so as to allow the unhindered mounting of a tonneau cover or camper top on the upper edge of the front wall of the pickup truck bed.

These and other features and advantages of the invention will become apparent from the detailed description below, in light of the accompanying drawings.

### BRIEF DESCRIPTION OF THE DRAWINGS

FIG. 1 is a perspective exploded assembly view from the rear of a pickup truck of an example storage curtain device according to the invention being mounted onto the front wall of the pickup truck bed.

FIG. 2 is similar to FIG. 1, showing the cap portion of the device mounted on the pickup truck bed, and a detachable curtain body exploded from the cap.

FIG. 3 is similar to FIGS. 1 and 2, showing the storage curtain device fully assembled to the pickup truck bed.

FIG. 4 is a side elevation sectional view of the installed storage curtain device of FIG. 3, with a portion of the truck bed sidewall cut away.

FIG. 5 is similar to FIG. 3, but shows an alternate form of cap on the upper side of the storage curtain in which the cap comprises a spaced array of rigid pieces.

FIG. 6 is similar to FIG. 1, but shows the cap portion of the storage curtain device and the curtain body formed as an integral assembly and exploded from the pickup truck bed.

### DETAILED DESCRIPTION

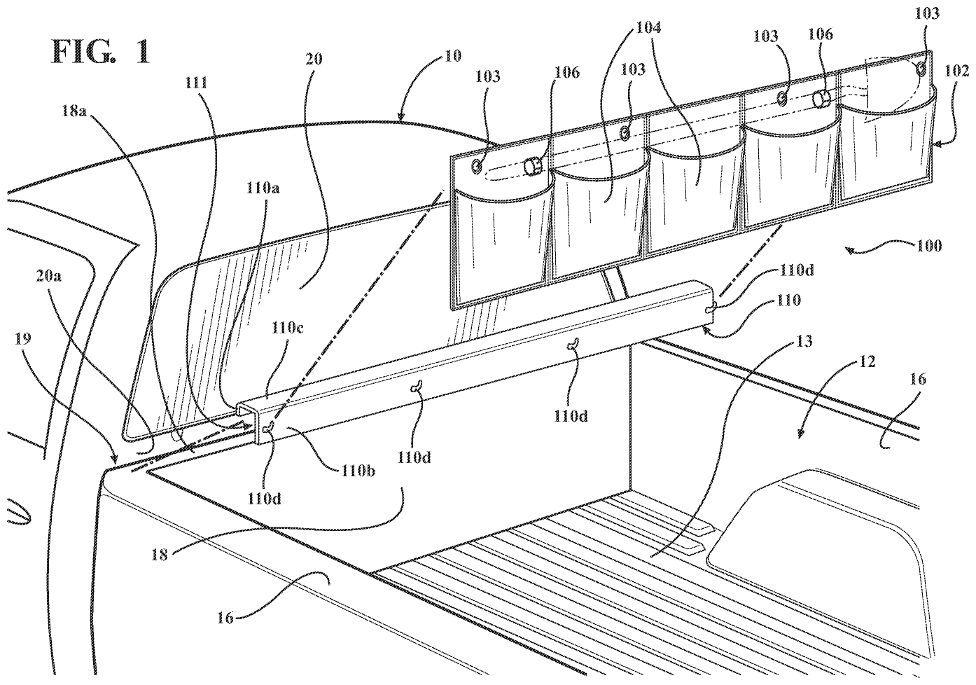

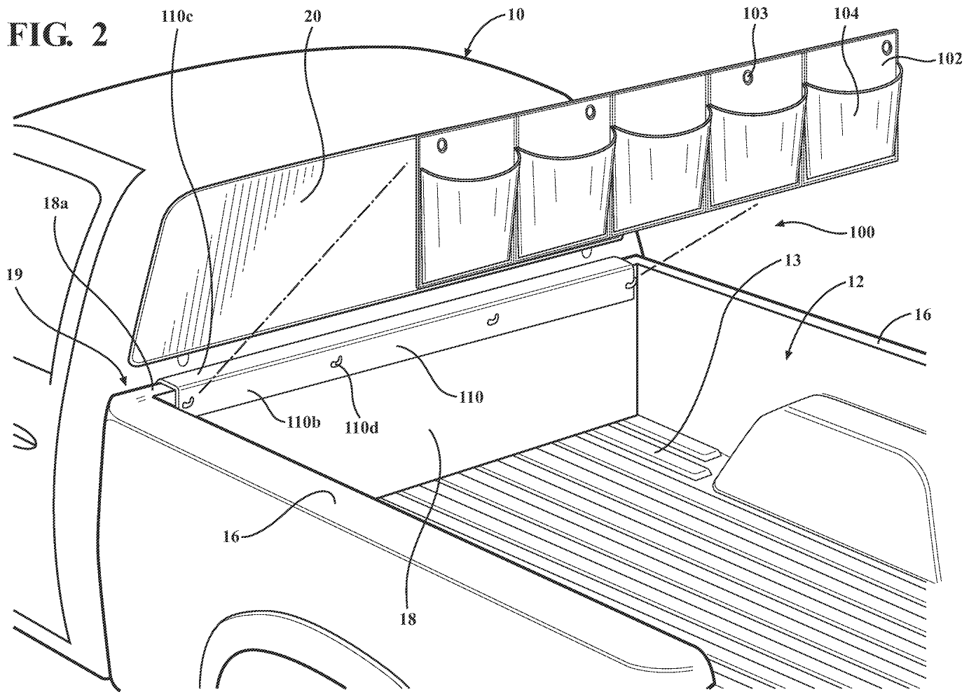

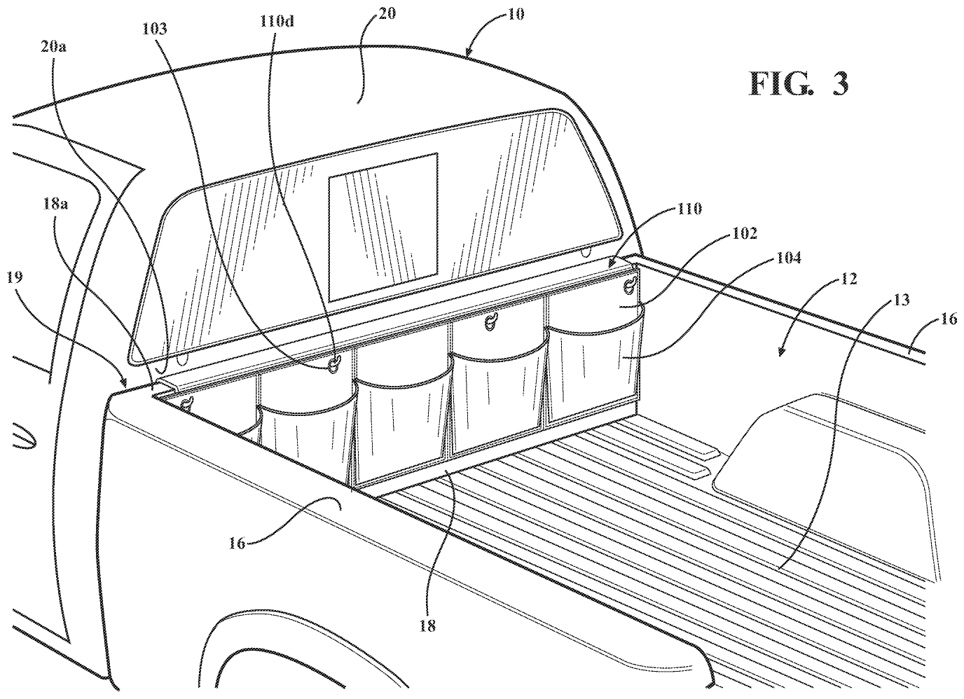

Referring to FIGS. 1 through 4, a storage curtain device 100 is shown in exemplary form relative to a schematically illustrated pickup truck 10, in order to teach how to make and use the claimed invention. Pickup truck 10 may be any known make or model of pickup truck with a rear cargo bed 12. While cargo bed 12 is illustrated as an open bed, the storage curtain device 100 may also generally be used with a cargo bed covered by a flat tonneau cover, a tarp, or even a raised camper-type top or “topper”.

Cargo bed 12 will typically have a floor 13, a rear gate (not shown) that can be raised and lowered in known fashion, raised sidewalls 16, and a generally flat, vertical front wall 18 located immediately behind the driver-passenger cab section 20 at the forward end of the bed. There is usually a small gap 19 between the upper edge 18a of front wall 18 and the rear wall 20a of cab 20, and it is to such cargo beds that the present invention is directed.

The interior portions and upper edges of the cargo bed 12 may be covered with a liner material in known fashion.

Cargo storage device 100 in the preferred, illustrated example comprises a curtain body 102 formed as a generally flat, panel-like portion sized to fit within the dimensions of front wall 18 of the pickup truck cargo bed 12. Accordingly, the width of curtain body 102 is equal to or less than the width of front wall 18 so that it fits without buckling or folding between the sidewalls 16, and the height of the curtain body 102 is less than the height of front wall 18 so that it may hang flat against the front wall 18 above floor

Curtain body 102 includes one or more holding features for storing or securing small to medium cargo such as tools, auto safety or repair equipment, spare parts, maps, personal effects, and the like, without limitation. Such holding features may include pouches 104 (covered with flaps, provided with closures, or open), internal compartments, and/or fastener straps or cords 106. The holding features are preferably made from relatively soft or collapsible materials so that, when not in use, these features preferably lie generally flat against curtain body 102, or are at least capable of being pressed generally flat against the curtain body 102 by cargo in the cargo bed 12.

The flat, panel-like curtain body 102 may be a flexible or rigid sheet or panel, for example made from a heavy fabric-type material such as canvas, nylon/polyester, or vinyl, or made from a lightweight sheet of metal, with equipment securing/storage features such as 104, 106 made of the same or a complementary material depending on the material chosen for body portion 102.

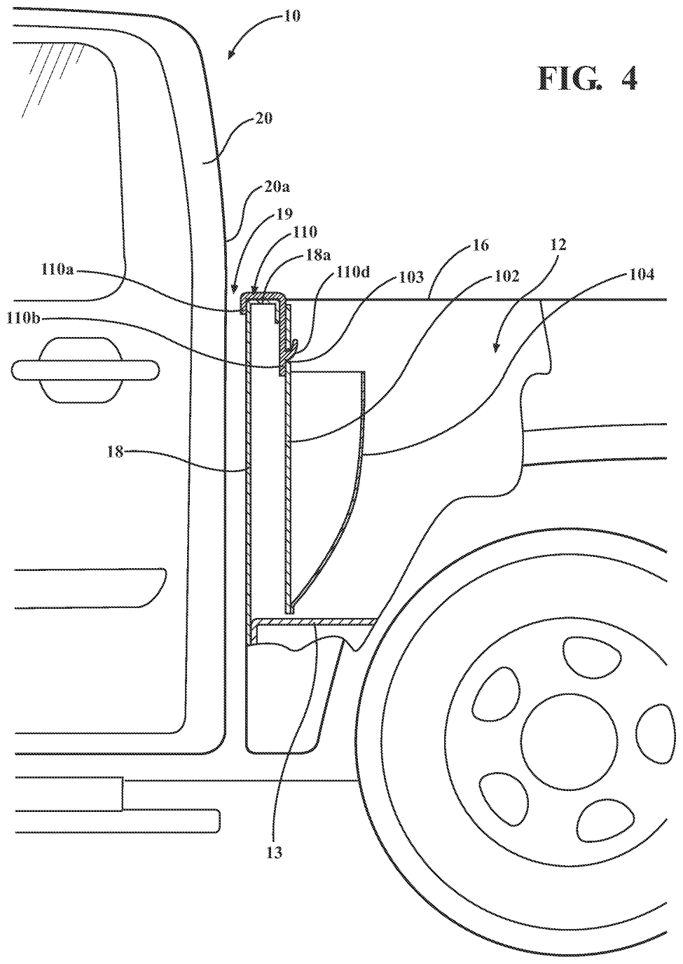

Cargo storage device 100 further comprises a rail or “cap” portion 110 that can be attached to the upper edge 18a of front wall 18, positioned to support curtain body 102 to hang or otherwise be generally vertically suspended therefrom against the front wall 18. In the illustrated example of FIGS. 1-4, cap 110 comprises a rigid piece having a length approximating the width of front wall 18, with an inverted, substantially J-shaped or inverted-hook cross-section defining an interior channel 111 sized to receive upper edge 18a of front wall 18. A vertical front lip 110a is sized to fit into gap 19 between the upper edge 18a of front wall 18 and the rear wall 20a of cab 20. A longer vertical rear flange 110b extends downwardly over the rear (cargo side) face of front wall 18, with preferably a parallel and close-conforming fit to the face of the front wall 18 as best shown in FIG. 4. An intermediate wall 110c joins front lip 110a to rear flange 110b, in the illustrated example a flat, thin wall 110c perpendicular to 110a and 110b. Cap 110 may be made from various materials that are reasonably rigid and strong in a thin-walled configuration, for example molded ABS plastic or sheet metal. Depending on the vertical depth of the gap 19 between the front edge 18a of the truck bed and the rear side 20a of the cab 20, the front lip 110a may be extended downwardly in length to more closely match the rear flange 110b, giving the cap 110 a more U-shaped inverted hook profile.

In the example of FIGS. 1-4, cap 110 further includes a plurality of connector points 110d on the rear flange 110b facing the cargo bed 12. Connector points 110d may be hooks as illustrated, studs, snaps, or similar strong mechanical connectors. Curtain body 102 includes mating connection features 103 along its upper edge, positioned and configured to detachably mate with connector points 110d on cap 110. While in the illustrated example a plurality of spaced connector points 110d are shown on cap 110, and a plurality of correspondingly spaced mating connection features 103 such as holes, mating snaps, etc. are shown on curtain body 102, one or the other sets of connector points/features on the cap and curtain portions may comprise a single feature running along some or all of the width of the cap and/or curtain to mate with either a single corresponding-length feature on the other, or with a plurality of spaced features on the other. By way of non-limiting example, if a plurality of spaced connector hooks 110d are located along cap 110, a single long slit opening may be provided along the upper edge of curtain body 102 instead of a plurality of spaced hook-receiving holes 103.

Connector points 110d on cap 110 allow curtain body 102 to be conveniently and detachably hung or suspended from the cap 110, in a generally vertical manner parallel to (and preferably flat against) front wall 18 of the cargo bed 12.

Cap 110 is preferably detachably mated over the upper edge 18a of front wall 18 of the cargo bed, resting over the upper edge or snapped in place with a close or frictional fit, so that it can be removed as desired as an aftermarket accessory without marring the existing truck bed finish or liner. Alternately, cap 110 may be more permanently attached to the upper edge 18 of front wall 18, for example with an adhesive, and essentially left permanently in place on the truck bed. In either case, a detachable curtain body 102 can be quickly attached and detached from the cap 110 as needed.

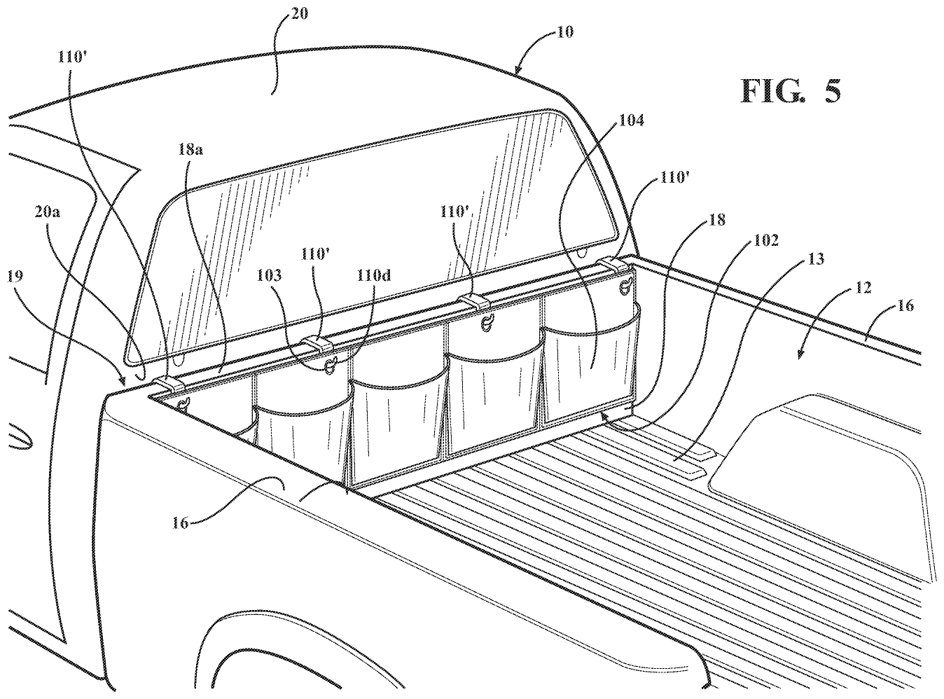

FIG. 5 shows an alternate form of cap 110, in which the cap comprises a plurality of separate, spaced portions 110′ of the same material, cross-section, and connector point features as the continuous, rail-like cap 110 of FIGS. 1-4, but individually placed on the upper edge 18a of front wall 18 with a desired spacing to match the connection features 103 on the curtain body 102.

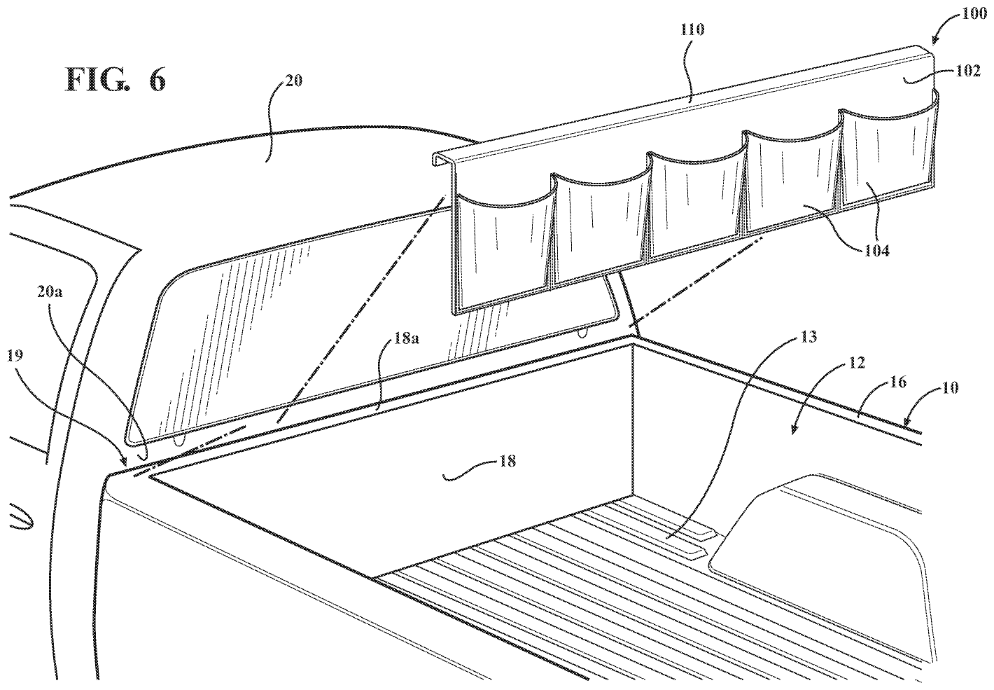

FIG. 6 shows another alternate form of the curtain storage device 100, in which cap 110 (whether continuous as in FIGS. 1-4 or spaced-apart sections as in FIG. 5) is integrated with the upper edge of curtain body 102, i.e. permanently attached thereto as by integral molding or forming, or with permanent mechanical fasteners or permanent adhesive if formed separately.

It will finally be understood that the disclosed embodiments represent presently preferred examples of how to make and use the invention, but are intended to enable rather than limit the invention. Variations and modifications of the illustrated examples in the foregoing written specification and drawings may be possible without departing from the scope of the invention. It should further be understood that to the extent the term “invention” is used in the written specification, it is not to be construed as a limiting term as to number of claimed or disclosed inventions or discoveries or the scope of any such invention or discovery, but as a term which has long been used to describe new and useful improvements in science and the useful arts. The scope of the invention supported by the above disclosure should accordingly be construed within the scope of what it teaches and suggests to those skilled in the art, and within the scope of any claims that the above disclosure supports in this application or in any other application claiming priority to this application.

1. A In combination with a pickup truck bed having a front wall with a gap between an upper edge of the front wall and a rear side of a cab portion of the pickup truck, a storage curtain device comprising:
a generally flat, panel-like curtain body including a plurality of soft, collapsible holding features on a rear face thereof for storing and/or securing small-to-medium items above a floor of the pickup truck bed;
a cap portion attached to an upper edge of the curtain body, the cap portion comprising a rigid inverted hook-shaped body opening forwardly and downwardly and configured to mate directly onto the upper edge of the front wall of the pickup truck bed, adjacent the cab; wherein,
the curtain body hangs freely in a generally vertical plane from the cap portion against the front wall of the pickup truck bed across the pickup truck bed above the floor of the pickup truck bed.

2. The storage curtain device of claim 1, wherein the cap portion comprises a rigid inverted generally J-shaped body, with a shorter vertical forward wall, a longer vertical rear wall spaced from the forward wall, and a horizontal wall joining the forward and rear walls, the cap portion defining an interior channel shaped to fit over the upper edge of the front wall of the pickup truck cab with the rear wall of the cap portion extending down along the front wall of the pickup truck bed.

3. The storage curtain device of claim 1, wherein the height of the curtain body is less than the height of the front wall of the pickup truck bed so that a lower edge of the curtain body is spaced above the floor of the pickup truck bed when the cap portion is mounted on the upper edge of the front wall of the pickup truck cab.

4. The storage curtain device of claim 1, wherein the curtain body is detachably connected to the cap portion.

5. The storage curtain device of claim 1, wherein the cap portion is detachably mounted over the upper edge of the front wall of the pickup truck bed.
